(19) United States
(12) Patent Application Publication
(10) Pub. No.: US 2016/0364915 A1
(43) Pub. Date: Dec. 15, 2016

(54) VIRTUAL REALITY CONTENT PRESENTATION INCLUDING VIEWPOINT TRANSITIONS TO PREVENT SIMULATOR SICKNESS

(71) Applicant: GOOGLE INC., Mountain View, CA (US)

(72) Inventors: Martin Hague SMITH, Barnet (GB); Francesco CAVALLARO, London (GB); Robert Hugh TANSLEY, London (GB)

(21) Appl. No.: 15/179,246

(22) Filed: Jun. 10, 2016

Related U.S. Application Data
(60) Provisional application No. 62/175,736, filed on Jun. 15, 2015.

(51) Int. Cl. G06T 19/00

(52) U.S. Cl. CPC G06T 19/006

(57) ABSTRACT

In a general aspect, a computer-implemented method can include displaying, on a display of an electronic device, an object from a first virtual reality (VR) viewpoint. The method can further include overlaying, on the display, a highlight within the first VR viewpoint of the object. The method can also further include transitioning, on the display of the electronic device without simulated motion, from displaying the object from the first VR viewpoint with the highlight to displaying the object from a second VR viewpoint. The second VR viewpoint can be a close-up view of a portion of the object that is within the highlight in the first VR viewpoint.

### CROSS REFERENCE TO RELATED APPLICATIONS

This application claims priority to provisional application 62/175,736, filed on Jun. 15, 2015, entitled “VIRTUAL REALITY CONTENT PRESENTATION INCLUDING VIEWPOINT TRANSITIONS TO PREVENT SIMULATOR SICKNESS,” the contents of which is incorporated herein by reference.

### TECHNICAL FIELD

This description generally relates to the use and presentation of virtual reality (VR) content.

### SUMMARY

In a general aspect, a computer-implemented method can include displaying, on a display of an electronic device, an object from a first virtual reality (VR) viewpoint. The method can further include overlaying, on the display, a highlight within the first VR viewpoint of the object. The method can also further include transitioning, on the display of the electronic device without simulated motion, from displaying the object from the first VR viewpoint with the highlight to displaying the object from a second VR viewpoint. The second VR viewpoint can be a close-up view of a portion of the object that is within the highlight in the first VR viewpoint.

Implementations can include one or more of the following features. For example, transitioning from displaying the object from the first VR viewpoint to displaying the object from the second VR viewpoint can include virtually teleporting from the first VR viewpoint to the second VR viewpoint. Transitioning from displaying the object from the first VR viewpoint to displaying the object from the second VR viewpoint can include simultaneously fading-out the first VR viewpoint and fading-in the second VR viewpoint. Transitioning from displaying the object from the first VR viewpoint to displaying the object from the second VR viewpoint can include simultaneously dissolving-out the first VR viewpoint and dissolving-in the second VR viewpoint.

The object can be virtually held in a fixed position in a VR space when displaying the object from the first VR viewpoint, transitioning from displaying the object from the first VR viewpoint to displaying the object from the second VR viewpoint and displaying the object from the second VR viewpoint.

The object can be a work of art included in digital content of a VR tour.

The highlight can be a first highlight and the computer-implemented method can include transitioning, on the display of the electronic device without simulated motion, from displaying the object from the second VR viewpoint to displaying the object from the first VR viewpoint with the overlaid first highlight and removing, from the display of the electronic device, the first highlight. The method can include overlaying, on the display, a second highlight within the first VR viewpoint of the object and transitioning, on the display of the electronic device without simulated motion, from displaying the object from the first VR viewpoint with the second highlight to displaying the object from a third VR viewpoint. The third VR viewpoint can be a close-up view of a portion of the object that is within the second highlight in the first VR viewpoint. The portion of the object that is within the second highlight can be different than the portion of the object that is within the first highlight.

In another general aspect, a non-transitory machine readable media can have instructions stored thereon. The instructions, when executed by one or more processors, can cause a computing device to display, on a display of the computing device, an object from a first virtual reality (VR) viewpoint. The instructions, when executed by the one or more processors, can further cause the computing device to overlay, on the display, a highlight within the first VR viewpoint of the object and transition, on the display of the computing device without simulated motion, from displaying the object from the first VR viewpoint with the highlight to displaying the object from a second VR viewpoint. The second VR viewpoint can be a close-up view of a portion of the object that is within the highlight in the first VR viewpoint.

Implementations can include one or more of the following features. For example, transitioning from display of the object from the first VR viewpoint to display of the object from the second VR viewpoint can include virtually teleporting from the first VR viewpoint to the second VR viewpoint. Transitioning from display of the object from the first VR viewpoint to display of the object from the second VR viewpoint can include simultaneously fading-out the first VR viewpoint and fading-in the second VR viewpoint. Transitioning from display of the object from the first VR viewpoint to display of the object from the second VR viewpoint includes simultaneously dissolving-out the first VR viewpoint and dissolving-in the second VR viewpoint.

The object can be virtually held in a fixed position in a VR space during display of the object from the first VR viewpoint, transition from display of the object from the first VR viewpoint to display of the object from the second VR viewpoint and display of the object from the second VR viewpoint.

The highlight can be a first highlight. The instructions, when executed by the one or more processors, can cause the computing device to transition, on the display of the computing device without simulated motion, from displaying the object from the second VR viewpoint to displaying the object from the first VR viewpoint with the overlaid first highlight; remove, from the display of the computing device, the first highlight; overlay, on the display of the computing device, a second highlight within the first VR viewpoint of the object; and transition, on the display of the computing device without simulated motion, from displaying the object from the first VR viewpoint with the second highlight to displaying the object from a third VR viewpoint. The third VR viewpoint can be a close-up view of a portion of the object that is within the second highlight in the first VR viewpoint. The portion of the object that is within the second highlight can be different than the portion of the object that is within the first highlight.

In another general aspect, an apparatus can include one or more processors and a non-transitory machine readable media operationally coupled with the one or more processors. The non-transitory machine readable media can have instructions stored thereon that, when executed by the one or more processors, result in the apparatus displaying, on a display of the apparatus, an object from a first virtual reality (VR) viewpoint; overlaying, on the display of the apparatus, a highlight within the first VR viewpoint of the object; and transitioning, on the display of the apparatus without simulated motion, from displaying the object from the first VR viewpoint with the highlight to displaying the object from a second VR viewpoint. The second VR viewpoint can be a close-up view of a portion of the object that is within the highlight in the first VR viewpoint.

Implementations can include one or more of the following features. For example, transitioning from displaying the object from the first VR viewpoint to displaying the object from the second VR viewpoint can include virtually teleporting from the first VR viewpoint to the second VR viewpoint. Transitioning from displaying the object from the first VR viewpoint to displaying the object from the second VR viewpoint can include simultaneously fading-out the first VR viewpoint and fading-in the second VR viewpoint. Transitioning from displaying the object from the first VR viewpoint to displaying the object from the second VR viewpoint can include simultaneously dissolving-out the first VR viewpoint and dissolving-in the second VR viewpoint.

The object can be virtually held in a fixed position in a VR space when displaying the object from the first VR viewpoint, transitioning from displaying the object from the first VR viewpoint to displaying the object from the second VR viewpoint and displaying the object from the second VR viewpoint.

The object is a work of art included in digital content of a VR tour.

The highlight can be a first highlight. The instructions, when executed by the one or more processors, can result in the apparatus transitioning, on the display of the apparatus without simulated motion, from displaying the object from the second VR viewpoint to displaying the object from the first VR viewpoint with the overlaid first highlight; removing, from the display of the apparatus, the first highlight; overlaying, on the display, a second highlight within the first VR viewpoint of the object; and transitioning, on the display of the apparatus without simulated motion, from displaying the object from the first VR viewpoint with the second highlight to displaying the object from a third VR viewpoint. The third VR viewpoint can be a close-up view of a portion of the object that is within the second highlight in the first VR viewpoint. The portion of the object that is within the second highlight can be different than the portion of the object that is within the first highlight.

### BRIEF DESCRIPTION OF THE DRAWINGS

FIG. 1 is a diagram that illustrates a system for presenting virtual reality (VR) content, in accordance with an implementation.

FIG. 2 is a block diagram schematically illustrating a VR “tour guide” and VR tour content that can be used in the system of FIG. 1, according to an implementation.

FIG. 3 is a block diagram that schematically illustrates VR content for a VR tour that can be included in the VR content of FIG. 2, according to an implementation.

FIGS. 4A-4F are diagrams illustrating VR viewpoint transitions, according to an implementation.

FIG. 5 is a diagram illustrating a stereoscopic view of the image of FIG. 4C, according to an implementation.

FIG. 6 is a diagram illustrating a VR viewpoint including annotations corresponding with the viewpoint, according to an implementation.

FIG. 7 is a flowchart illustrating a method for implementing VR viewpoint transitions, such as the VR viewpoint transitions of FIGS. 4A-4F, according to an implementation.

FIG. 8 shows an example of a computer device and a mobile computer device that can be used to implement the techniques described here.

Like reference symbols in the various drawings indicate like elements.

### DETAILED DESCRIPTION

The following description is generally directed to the use of virtual reality (VR) content (such as three-dimensional (3D) images (VR images), 3D videos (VR videos), audio, informational annotations, etc.) in the context of providing a user with a VR art museum or art gallery tour (hereafter “museum tour”) experience. It will be appreciated, however, that the approaches described herein can also be used in other settings, such as institutions other than museums/galleries, such as educational settings, professional presentations, tradeshow presentations, conference presentations, e.g., so as to allow for viewing of, and close examination of a given number object (or objects).

For instance, the techniques described herein could be used in an instructional setting, such as a vocational course on automotive repair. For example, the approaches described herein could be used to transition between a 3D image of an entire automotive engine and close up VR images of different components (portions, sections, etc.) of the engine. Of course, the use of the approaches described herein can also be used in any number of other settings.

In this disclosure, images may be shown as 2D images or stereoscopic (3D) images, and such images are shown by way of illustration. In implementations, VR images, VR graphics, VR videos, as well as other elements, arrangements of such elements and/or approaches for presenting such VR content may be used other than those described herein. In the approaches described herein, as well as other approaches, VR visual content, such as 3D images, 3D photospheres, 3D videos, etc., can be used to provide users with an immersive 3D, VR museum tour experience. For instance, VR hardware and/or VR content can be used by users to take VR museum tours in places that may not be readily accessible to them, or on a timetable that could not be accomplished by a physical visit (or visits). For example, using the approaches described herein, a user could (from anywhere in the world) take a VR tour of the Metropolitan Museum of Art in New York City and then, immediately after, take a VR tour of The Louvre in Paris, without the need to travel. In other implementations, VR tours (exhibits) could be provided that are related in other ways than based on a specific physical institution. For instance, such a VR tour could include works from a single artist, works of a related group of artists, works of a given genre or period, etc., where those works are physically located at different institutions in geographically different locations.

In the following description, systems and techniques for taking (experiencing, etc.) VR museum tours are described, which are provided by way of example and for purposes of illustration. Such systems can include, at least, a content component, a software component and a hardware component. The specific components used can depend, at least, on the particular implementation.

In implementations, content for such VR museum tours can include collections of high-resolution 3D (VR) digital images, photographic panoramas, photospheres, along with other digital content, such as audio content (curator narration, music, etc.), informational notations, and so forth. For instance, images implemented as part of a VR museum tour can be high-quality, high-resolution, stereoscopic images (e.g., panoramas, tiled images and/or photospheres) that provide an immersive 3D experience as part of a VR museum tour. For purposes of clarity, hereafter, the terms VR, 3D and stereoscopic can be used interchangeably to refer to visual content that is used to provide an immersive, VR visual experience. Content (e.g., visual content) for VR museum tours (or content for use in other settings) can be obtained from any number of available sources, such as existing image and/or video collections (e.g., Internet-based collections, private collections, museum curators, etc.), such as by partnering with owners of such content.

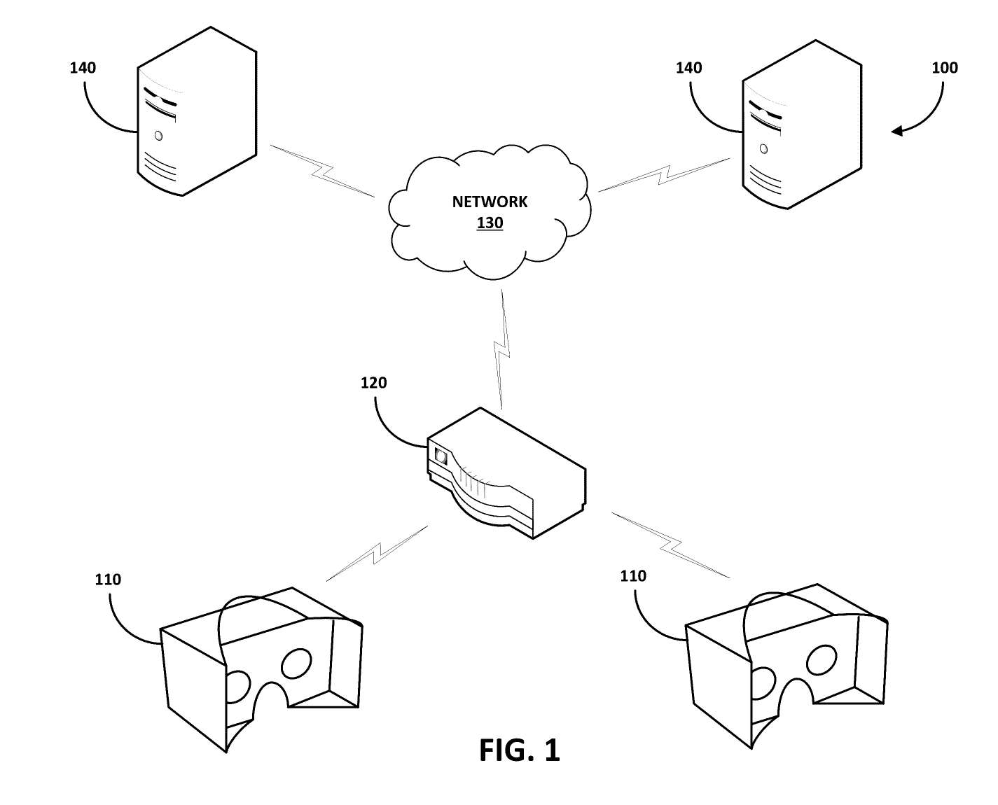

Hardware, software and content arrangements that can be used for experiencing a VR tour (e.g., a VR museum tour) are shown in FIGS. 1-3, which are discussed further below. Briefly, however, the hardware component of one implementation can include a VR viewer, a data network (such as the Internet), a data routing device (e.g., to provide an interface between the VR viewer and the data network), and a server (e.g., to store content associated with VR museum tours). In other implementations, other hardware can be used, or other arrangements are possible. For instance, in an implementation, VR content could be included in a VR viewer (such as an electronic device included in a VR viewer). In such an approach, the networking components (e.g., data network and router) and/or the server could be eliminated.

In an example implementation, the software component for implementing VR museum tours can be a VR museum and gallery “tour guide” application. In such an approach, the tour guide application can access VR content associated with a given museum or gallery and present that VR content as a guided VR museum tour, such as a tour of a museum selected from a user interface (e.g., included in the VR content) that can be presented with a VR viewer running the tour guide application software.

Depending on the implementation, a VR tour of a given museum can be a fully “guided tour”, where a viewer can control a pace of the tour using an input device on the VR viewer to move from one curated portion of the tour to the next. In other implementations, a VR tour of a museum can be a “self-guided” tour, where a user can explore a selected museum in a VR space (e.g., using VR content associated with the museum) and select works they wish to view. When a work is selected, the tour guide application may then present a high resolution image of the work, curator narration about the work and/or textual annotations about the work. The tour guide application can also provide a number of viewpoint transitions, using the approaches described herein, so the user can more closely examine the selected work. The presentation of the viewpoint transitions can be predetermined or can be made in response to selection of specific area of a work being viewed. In other implementations, a VR museum tour can be a combination of curator guided and self-guided.

FIG. 1 is a diagram that illustrates a system 100 for implementing (taking, experiencing, etc.) VR museum tours (or other VR content), in accordance with an implementation. As shown in FIG. 1, the system 100 includes multiple VR viewers 110 that can be used to view VR museum tour content. While two VR viewers 110 are shown in FIG. 1, in other implementations a single VR viewer 110 or additional VR viewers 110 can be used. Further, the VR viewers 110 could be used by multiple users to take the same VR museum tour simultaneously, or to take different VR museum tours, or to view other types of tours, exhibitions and/or presentations. For purposes of clarity, the description of FIG. 1 below references a single VR viewer 110.

The system 100 can also include a router 120 that is used to provide data connections between the VR viewer 110 and a network 130 (e.g., the Internet or other data network, such as a local network) and servers 140, which are operationally connected with the network 130. The servers 140 can store VR content associated with VR museum tours, such as the content discussed herein. While multiple servers 140 are shown in FIG. 1, in other arrangements, a single server 140 or additional servers 140 can be used.

In some implementations, VR content for VR museum tours can be loaded directly on the VR viewer 110 (e.g., such as by downloading the VR content from one or more of the servers 140 via the network 130 and the router 120. In such an approach, the VR viewer 110 can be used to experience a VR museum tour (or other downloaded VR content) without having to be “online” (e.g., connected to the router 120, the network 130 and one or more of the servers 140).

While the data connections in FIG. 1 are illustrated as being wireless connections, wired connections can also be used. In other implementations, one or more of the servers 140 could operate as a wireless network hotspot. In such an approach, the router 120 and the network 130 could be omitted, and the VR viewer 110 could connect directly with the servers 140. In still other implementations, the system 100 could include other data and/or network devices, such as a modem to provide Internet (or other network) connectivity and/or other types of data storage devices to store VR content, as some examples.

In an implementation, the VR viewer 110 can be implemented as a single, integrated device. For example, the VR viewer 110 can include an electronic device (e.g., smartphone, tablet, etc.) that is integrated (e.g., permanently installed) in a set of VR goggles. In such an implementation, the electronic device would not need to be inserted and removed from the VR viewer 110, reducing setup time. In other implementations, the electronic device of the VR viewer 110 can be separable from (e.g., insertable to and removable from) the VR goggles of the VR viewer 110, such as using a flap, door, or the like, included in the VR goggles. In such an approach, the electronic device of the VR viewer 110 can be inserted in the VR goggles when starting a VR museum tour and then removed from the VR viewers 110 after completing the VR museum tour (e.g., to recharge the electronic devices, use for other purposes, etc.). The VR viewer 110 (integrated or separable) can include VR optics (e.g., aspherical lenses) in its VR goggles, and the VR goggles can have a housing made of any appropriate material (e.g., plastic, rubber, cardboard, or other material).

While not shown in FIG. 1, the system 100 can also include one more audio systems that can be used to provide audio content (e.g., museum curator narration) during a VR museum tour. Such audio systems can include a speaker that is wirelessly connected with (e.g., using a BLUETOOTH connection, or other wireless connection) the VR viewer 110 (e.g., an electronic device of the VR viewer 110). In other implementations, the VR viewer 110 can include an integrated (internal) speaker or audio headset (headphones).

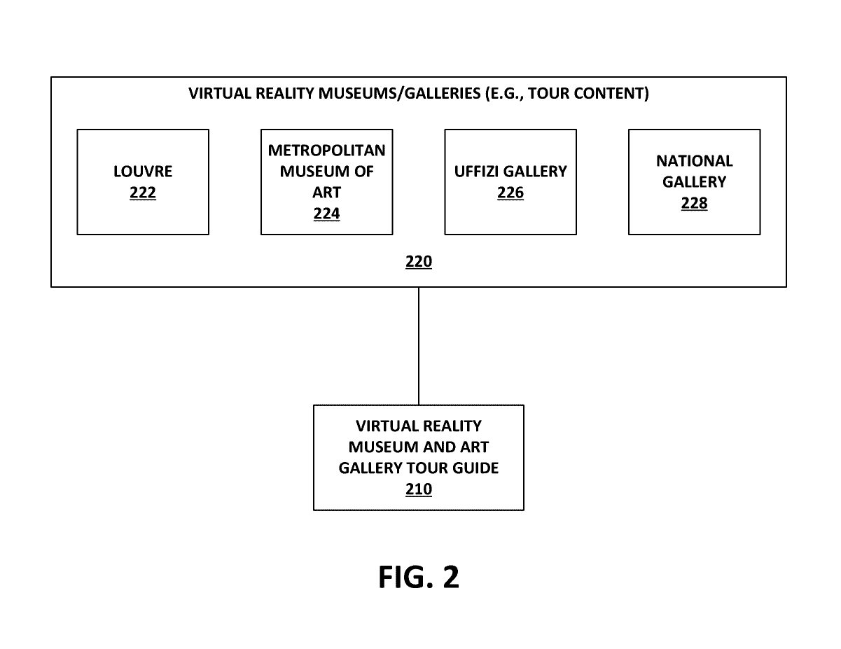

FIG. 2 is a block diagram schematically illustrating a VR “tour guide” (tour guide) 210 and VR tour content (tour content) 220 that can be used in the system of FIG. 1 to implement (present, experience, etc.) VR museum tours, according to an implementation. For purposes of illustration, FIG. 2 will be described with reference to the system 100 of FIG. 1. In other implementations, the tour guide 210 and the tour content 220 can be used in conjunction with systems having other configurations and/or for presenting any appropriate VR content.

The tour guide 210 can be configured to access the tour content 220 for a given museum (e.g., a museum selected from a user interface) and present the tour content 220 as a VR museum tour using the VR viewer 110. The tour guide 210 can be implemented in a number of ways. For example, the tour guide 210 can be implemented as an application that is installed and runs (e.g., is executed by a processor) on an electronic device of the VR viewer 110. In another implementation, the tour guide 210 can be a web-based application that is accessible and runs from a web-based portal (e.g., such as a VR museum tour portal). In other implementations tour guide 210 can be implemented in other ways.

For instance, a tour guide application 210 that is branded for a particular institution and hosts tours for that institution can be provided. In such an approach, when the tour guide application is executed, a set of tours for the corresponding institution can be displayed. The number of, and the content of the tours can be determined by the institution (e.g., by a curator) and can be updated on a content server (e.g., the servers 140) as desired. Such content can then be downloaded to a VR viewer 110 to experience such tours. As some example tour possibilities, a curator might create a detailed guided tour of a famous artwork, a tour including a walk-through of a gallery with audio guidance, works of a specific artist (which can be in physically different geographic locations), and/or a high level overview of the top exhibits of a given institution artist, genre or period.

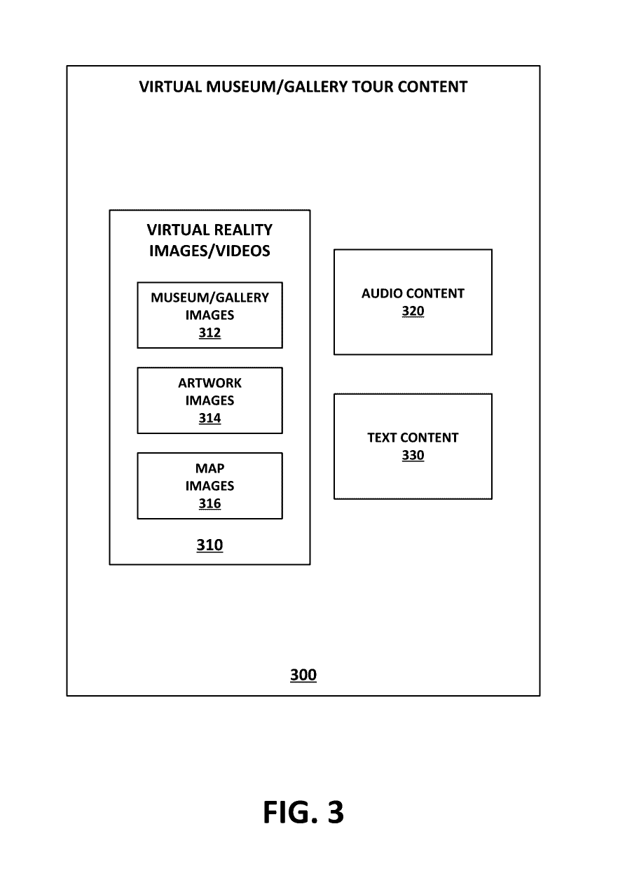

As shown in FIG. 2, the tour content 220 can include VR tour content for multiple museums and art galleries. For instance, the tour content 220 can include VR content for a VR museum tour of the Louvre 222, a VR museum tour of the Metropolitan Museum of Art 224, a VR museum tour of the Uffizi Gallery 226 and a VR museum tour of the National Gallery 228. The tour content 220 is shown by way of example and other VR content can be included and/or the specific museums and galleries shown in FIG. 2 can be omitted. Example content for a given museum or gallery (which can be works of a physical museum or gallery, or can be works of a purely virtual museum or gallery) is illustrated in FIG. 3, which is discussed below. In and example implementation, the individual tours (e.g., museums, galleries, etc.) included in the tour content 220 can be presented in a user interface (e.g., on a webpage) from which a desired VR tour can be selected.

FIG. 3 is a block diagram that schematically illustrates VR content for a VR museum/gallery tour (VR tour) 300 that can be included in the VR museums/galleries 220 of FIG. 2, according to an implementation. For example, the VR tour 300 can be used to implement a VR tour for a given one of the VR museums/galleries 220 shown in FIG. 2. For purposes of illustration, FIG. 3 will be described with reference to FIGS. 1 and 2. In other implementations, other configurations and arrangements can be used.

As illustrated in FIG. 3, the VR tour 300 can include VR images/videos 310, audio content 320 and text content 330. As further illustrated in FIG. 3, the VR images/videos 310 can include museum/gallery images 312, artwork images 314 and map images 360. The museum/gallery images 312 can be VR images (photospheres, panoramas, videos, tiled images, etc.) of the exterior and/or interior of a museum or gallery that is the subject of the VR tour 300. The artwork images 314 can be VR images (photospheres, panoramas, videos, tiled images, etc.) of works that are on display in the museum or gallery (physical or virtual) that is the subject of the VR tour 300. The map images 316 can be VR images (photospheres, panoramas, videos, tiled images, etc.) of maps associated with the museum or gallery that is the subject of the VR tour 300, such as a floor plan (from which an area to tour can be selected), a map showing the location of the museum or gallery, etc.

The VR images/videos 310 can be used by the tour guide 210 to implement a curated (guided) VR tour and/or to allow for independent exploration (within an available VR space corresponding with the VR images/videos 310) of an associated museum or gallery. The tour guide 210 can also use audio content 320 (e.g., curator narration) and text content 330 (e.g., informational annotations, etc.) in conjunction with the images/videos 310 to present the VR tour 300 on the VR viewer 110. For instance, in an implementation, a VR tour 300 could start outside a corresponding museum with curator narration (audio content 320) and/or display of informational annotations (text content) about the museum, with a viewer being able to examine (explore) the images/video 310 presented in VR space (e.g., by moving their head, which can be detected by the electronic device using an accelerometer).

The VR tour could then continue (e.g., as a curator guided or self-guided tour) inside the museum and to individual works “displayed” in the museum or gallery corresponding with the VR tour 300. Relevant audio content 320 and text content 330 (determined by a location with the VR tour 300) can be presented by the tour guide 210 as part of the VR tour 300. The specific ordering and selection of content presented for a given VR tour 300 can vary based on the implementation. As discussed above, an input device of the VR viewer 110 can be used to control the pace of a guided tour (e.g., to proceeding from one curated portion to a next curated portion) and/or to make selections within the VR tour 300 to experience a self-guided tour.

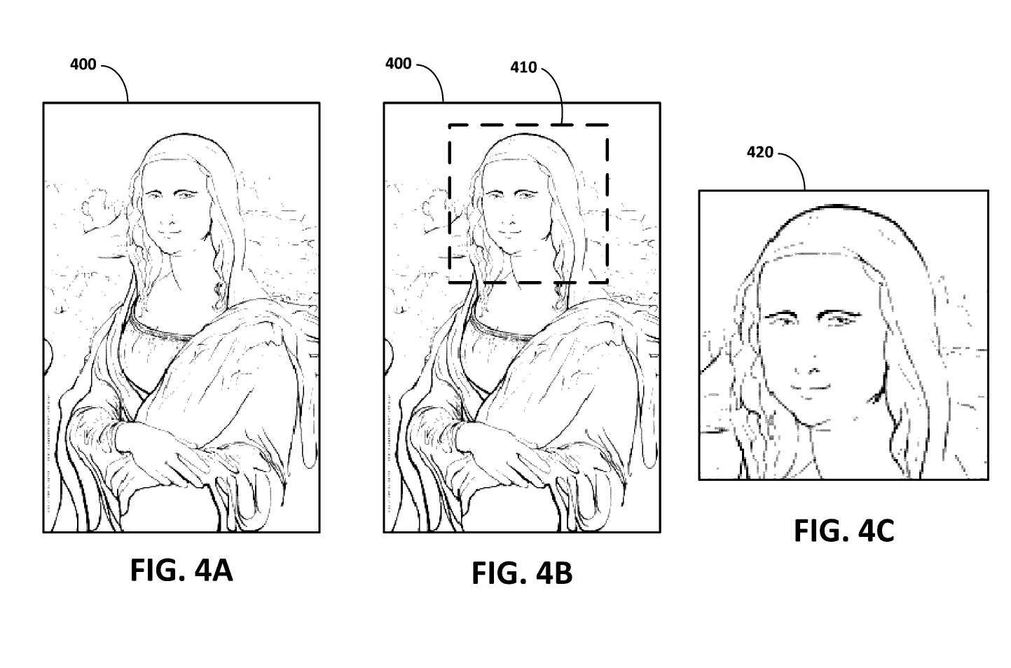

FIGS. 4A-4F are diagrams illustrating VR viewpoint transitions, according to an implementation. For purposes of this disclosure, FIGS. 4A-4F are described with reference to FIGS. 1-3, as appropriate. The viewpoint transitions illustrated by FIGS. 4A-4F can be used (implemented by) the tour guide 210 when presenting a work of art from the images 314 on the viewer 110 during presentation of the VR tour 300.

The approach for transitioning VR viewpoints (e.g., of a work of art) shown in FIGS. 4A-4F can prevent motion sickness, as movement between VR viewpoints is not apparent to (e.g., hidden from) the user. The approach illustrated in FIGS. 4A-4F, and described herein, allows for viewing an entire object (e.g., a work of art), as well as for close examination of one or more portions of that object. Using the approaches described herein to provide an immersive VR experience, a viewer can have the perception of being suspended in front of an object (e.g., a work of art) being examined, whether viewing the object as a whole, or viewing a specific portion (e.g., a close-up view) of the object.

In the viewpoint transitions of FIG. 4A-4F, the object being examined (e.g., a work of art) can be held in a fixed location in the VR space used to display the VR image (or images, such as for a tiled image) of the object, while a viewer can be “teleported” (e.g., moved, virtually moved, virtually teleported) from one viewpoint to another (e.g., different close up views of different sections of the object being examined) without virtual movement associated with these transitions being perceptible to the viewer in the VR space. Making such teleported viewpoint transitions, because movement from one viewpoint to another is hidden from a viewer, can prevent simulator (motion) sickness that could occur if that virtual movement is made apparent to the viewer (such as by using fly-in and/or fly-out animation). Such viewpoint transitions can include presenting (providing) one or more intermediate contextual views, which indicate(s) to a viewer where their viewpoint was (e.g., what section of the work they were viewing, or where they “teleported” from) and/or where their viewpoint is going (e.g., what section of the work they are about to view, or where they are being “teleported” to).

In the example of FIGS. 4A-4F, images of Da Vinci's Mona Lisa are presented. These images are given for purposes of illustration, and other objects can be viewed (presented, examined, etc.) using the viewpoint transitions approach illustrated by FIGS. 4A-4F. As shown in FIG. 4A, a VR image 400 of the Mona Lisa can be presented using the VR viewer 110. The image 400 can be a very-high resolution digital VR image (e.g., a Gigapixel image), such as a tiled, high-resolution image of the Mona Lisa work. As noted above, in the VR space, a viewer can have the perception of floating in front of the image 400. As shown in FIG. 4B, a highlight (frame, highlight frame, etc.) 410 can be super-imposed on the image 400, where the highlight 410 can be added as a guided part of the VR tour 300 to draw a viewer's attention to that section of the object, or could be added in response to a selection made by the viewer with the VR viewer 110 (e.g., an input mechanism of the VR viewer 110).

In this example, the VR viewpoint of FIG. 4B (image 400 with the highlight 410) can be transitioned to the VR viewpoint of FIG. 4C (image 420, which is the region of the Mona Lisa within the highlight 410 in FIG. 4B), by “teleporting” from the viewpoint of FIG. 4B to the viewpoint of FIG. 4C. Such a teleportation between the viewpoints of FIG. 4B and FIG. 4C can be accomplished by simultaneously dissolving out (e.g. fading to black) the viewpoint of FIG. 4B and dissolving in (e.g., fading in) the viewpoint of FIG. 4C in the VR space of the VR tour 300. While the change in viewpoints between FIG. 4B and FIG. 4C corresponds with virtual movement (camera movement) from the viewpoint of the image 410 in FIG. 4B to the viewpoint of the image 420 of FIG. 4C, which could result in simulator sickness if perceptible to a viewer, using the viewpoint teleportation transition described above makes such movement imperceptible to (e.g., hidden from) a viewer, thus preventing simulator sickness as a result of that movement.

FIG. 4C-4F illustrate viewpoint transitions (using the approaches described above) to transition from the close-up VR viewpoint of the image 420 shown in FIG. 4C to the close-up VR viewpoint of the image 430 shown in FIG. 4F, where the image 430 is a close-up view of a different section of the Mona Lisa than the image 420. The transition between the viewpoints of FIGS. 4C and 4F can include intermediate (contextual) transitions (views) that illustrate to a viewer of the VR tour 300 where on the object being examined they were viewing (FIG. 4D) or teleported (transitioned) from, and where on the object they will be viewing next (FIG. 4E) or are being teleported (transitioned) to (FIG. 4F).

The transition between the viewpoints of FIG. 4C and FIG. 4F, with two intermediate contextual transitions, can be accomplished as followed. First, a transition (teleportation) between the viewpoints of FIG. 4C and FIG. 4D can be made by simultaneously dissolving out (e.g. fading to black, fading out, etc.) the viewpoint of FIG. 4C and dissolving in (e.g., fading in, etc.) the viewpoint of FIG. 4D. In this example, the viewpoint in FIG. 4D can be the same viewpoint as shown in FIG. 4B, including the highlight 410. This transition between the viewpoints of 4C and 4D provides a viewer of the VR tour 300 with the context of where (the area of an object being examined) they were viewing (e.g., Mona Lisa's smile) before being teleported back out to the viewpoint of FIG. 4D (e.g., the entire Mona Lisa work).

A next step in a transition between the viewpoints of FIG. 4C and FIG. 4F with intermediate contextual transitions (views) is shown in FIG. 4E where the highlight 410 is moved from its location in FIG. 4D (and FIG. 4B) to a different location on the image 410 (e.g., Mona Lisa's hands) to provide context to a viewer of where on the object (Mona Lisa work) they are being teleported (transitioned to), such as illustrated in FIG. 4E. To complete the transition between the viewpoints of FIG. 4C and FIG. 4F of this example, a transition (teleportation) between the viewpoints of FIG. 4E and FIG. 4F can be made by simultaneously dissolving out (e.g. fading to black) the viewpoint of FIG. 4E and dissolving in (e.g., fading in) the viewpoint of FIG. 4F (e.g., to teleport a view from the VR viewpoint of FIG. 4E to the VR viewpoint of FIG. 4F). Such approaches allow for providing an immersive, VR museum tour experience (or to experience other VR content) where viewpoint transitions can be made between wide views and close up views of works of art (or other objects) without virtual motion associated with these viewpoint transitions being apparent to a viewer, thus preventing simulator sickness that can be caused by such virtual motion.

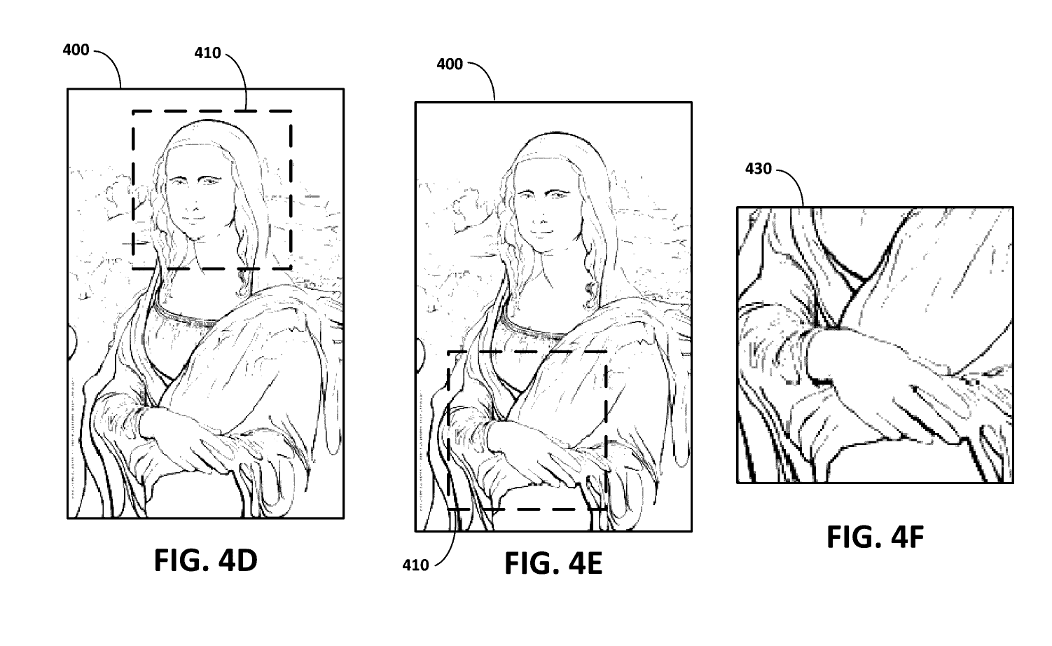

FIG. 5 is a diagram illustrating stereoscopic VR viewpoint 500 of the image 420 of FIG. 4C, according to an implementation. The stereoscopic view 500 may be presented in a VR viewer, such as the VR viewer 110 of FIG. 1. When viewed through the aspherical lenses of the VR viewer 110, the image 420 in the stereoscopic view 500 can appear as a single 3D image, so as to allow a viewer to experience an immersive VR experience when examining an object, in this instance, the Mona Lisa.

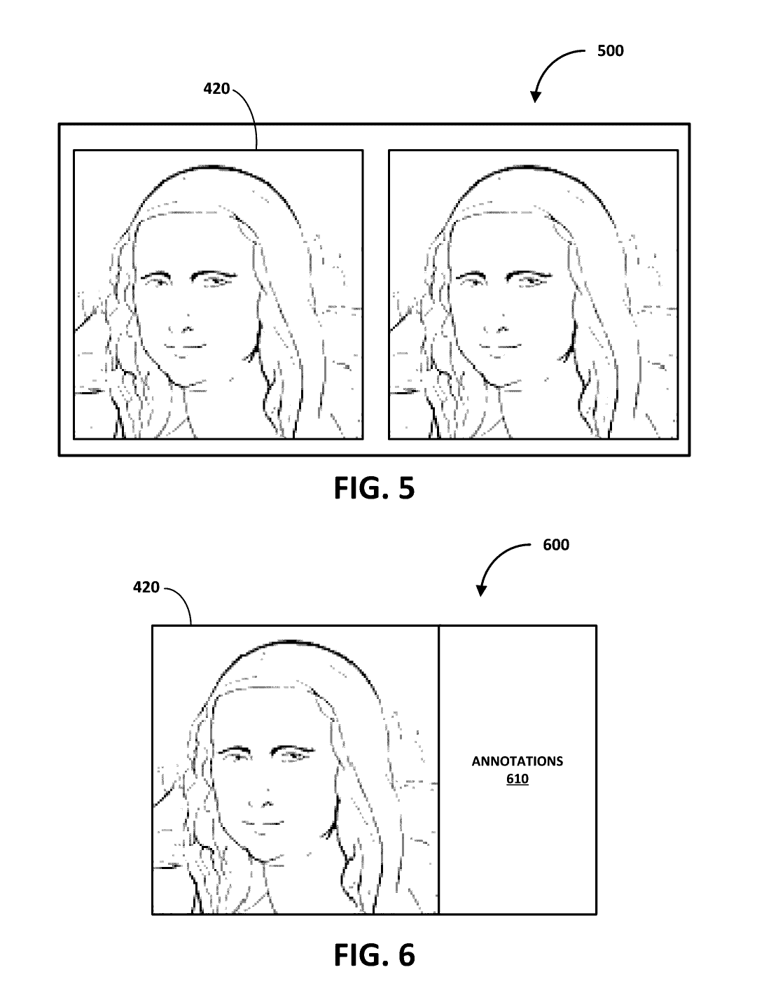

FIG. 6 is a diagram illustrating a VR viewpoint 600 of the image 420 that can be used in providing a VR museum tour, according to an implementation. As shown in FIG. 6, the viewpoint 600 can include annotations 610 that are disposed adjacent to the image 420. The annotations 610 can include informative information (e.g., curator notes, history, etc.) about the image 420. Depending on the implementation, the annotations 610 can be used alone or in combination with audio narration content of a VR museum tour. In other implementations, the annotations 610 and the image 420 could arranged in different fashions. For instance, the annotations could be super-imposed on the image 420 (e.g., could fade in and out in coordination with curated audio content). Still other approaches for the use of such annotations are possible.

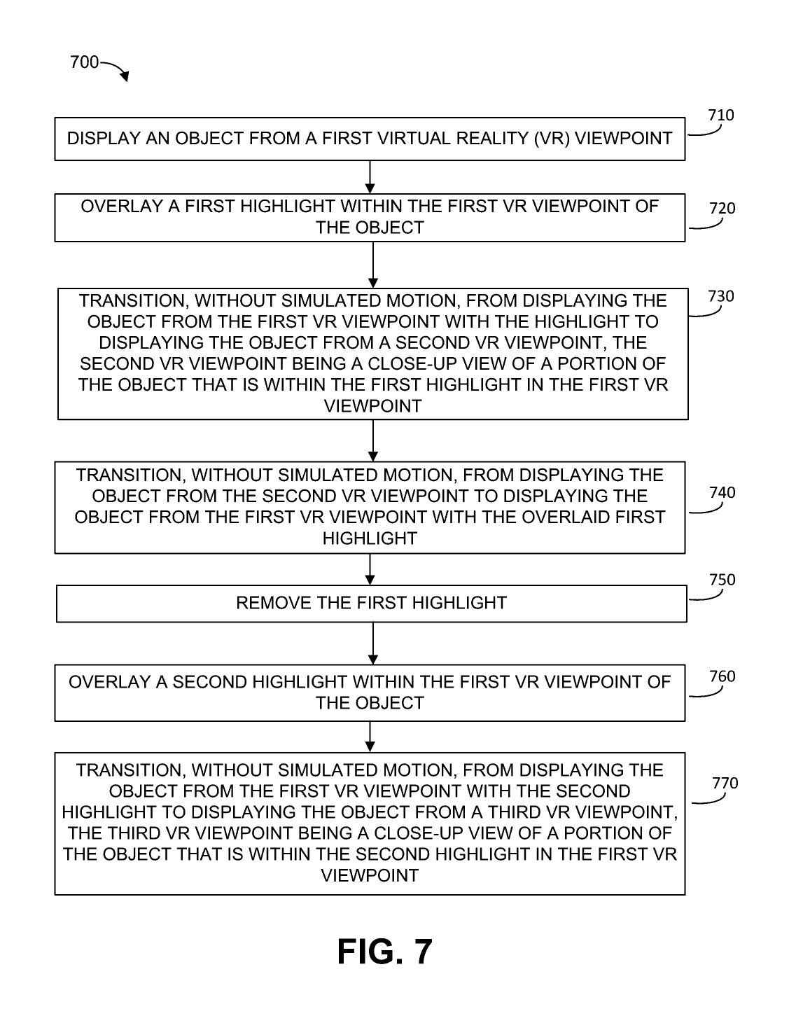

FIG. 7 is a flowchart illustrating a method 700 for implementing VR viewpoint transitions, such as the VR viewpoint transitions illustrated in FIGS. 4A-4F, according to an implementation. The method 700 can be implemented in the system 100 using the approaches described herein, such as using the VR tour guide of FIG. 2 and/or the VR tour content of FIG. 3, as some examples. For purpose of illustration, the method 700 will be described with further reference to the other drawings, as appropriate.

As shown in FIG. 7, the method 700 can include displaying, e.g., on a display of an electronic device (the VR viewer 110, a computing device, and so forth), an object (e.g., a VR image of an object) from a first virtual reality (VR) viewpoint, such as a VR viewpoint shown in FIG. 4A. At block 720, the method 700 can include overlaying, on the display, a first highlight within the first VR viewpoint of the object, such as in the viewpoint shown in FIG. 4B. At block 730, the method 700 can include transitioning, on the display without simulated motion (e.g., virtually teleporting, dissolving in/out, fading in/out, etc.), from displaying the object from the first VR viewpoint with the first highlight to displaying the object from a second VR viewpoint. The second VR viewpoint can be a close-up (magnified) view of a portion of the object that is within the first highlight in the first VR viewpoint.

At block 740, the method 700 can include transitioning, on the display (of an electronic device) without simulated motion (e.g., virtually teleporting, dissolving in/out, fading in/out, etc.), from displaying the object from the second VR viewpoint to displaying the object from the first VR viewpoint with the overlaid first highlight, such as the VR viewpoint of FIG. 4D, which as noted above can be the same of the VR viewpoint of FIG. 4B. At block 750, the method 700 can further include removing the first highlight and, at block 760, overlaying a second highlight within the first VR viewpoint of the object, such as in the viewpoint shown in FIG. 4E. At block 770, the method 700 can include transitioning, without virtual motion (e.g., virtually teleporting, dissolving in/out, fading in/out, etc.), from displaying the object from the first VR viewpoint with the second highlight to displaying the object from a third VR viewpoint. The third VR viewpoint can be a close-up view of a portion of the object that is within the second highlight in the first VR viewpoint. As discussed herein and illustrated in FIGS. 4A-4F, the portion of the object that is within the second highlight can be different than the portion of the object that is within the first highlight.

In a general aspect, a computer-implemented method can include displaying, on a display of an electronic device, an object from a first virtual reality (VR) viewpoint. The method can further include overlaying, on the display, a highlight within the first VR viewpoint of the object. The method can also further include transitioning, on the display of the electronic device without simulated motion, from displaying the object from the first VR viewpoint with the highlight to displaying the object from a second VR viewpoint. The second VR viewpoint can be a close-up view of a portion of the object that is within the highlight in the first VR viewpoint.

Implementations can include one or more of the following features. For example, transitioning from displaying the object from the first VR viewpoint to displaying the object from the second VR viewpoint can include virtually teleporting from the first VR viewpoint to the second VR viewpoint. Transitioning from displaying the object from the first VR viewpoint to displaying the object from the second VR viewpoint can include simultaneously fading-out the first VR viewpoint and fading-in the second VR viewpoint. Transitioning from displaying the object from the first VR viewpoint to displaying the object from the second VR viewpoint can include simultaneously dissolving-out the first VR viewpoint and dissolving-in the second VR viewpoint.

The object can be virtually held in a fixed position in a VR space when displaying the object from the first VR viewpoint, transitioning from displaying the object from the first VR viewpoint to displaying the object from the second VR viewpoint and displaying the object from the second VR viewpoint.

The object can be a work of art included in digital content of a VR tour.

The highlight can be a first highlight and the computer-implemented method can include transitioning, on the display of the electronic device without simulated motion, from displaying the object from the second VR viewpoint to displaying the object from the first VR viewpoint with the overlaid first highlight and removing, from the display of the electronic device, the first highlight. The method can include overlaying, on the display, a second highlight within the first VR viewpoint of the object and transitioning, on the display of the electronic device without simulated motion, from displaying the object from the first VR viewpoint with the second highlight to displaying the object from a third VR viewpoint. The third VR viewpoint can be a close-up view of a portion of the object that is within the second highlight in the first VR viewpoint. The portion of the object that is within the second highlight can be different than the portion of the object that is within the first highlight.

In another general aspect, a non-transitory machine readable media can have instructions stored thereon. The instructions, when executed by one or more processors, can cause a computing device to display, on a display of the computing device, an object from a first virtual reality (VR) viewpoint. The instructions, when executed by the one or more processors, can further cause the computing device to overlay, on the display, a highlight within the first VR viewpoint of the object and transition, on the display of the computing device without simulated motion, from displaying the object from the first VR viewpoint with the highlight to displaying the object from a second VR viewpoint. The second VR viewpoint can be a close-up view of a portion of the object that is within the highlight in the first VR viewpoint.

Implementations can include one or more of the following features. For example, transitioning from display of the object from the first VR viewpoint to display of the object from the second VR viewpoint can include virtually teleporting from the first VR viewpoint to the second VR viewpoint. Transitioning from display of the object from the first VR viewpoint to display of the object from the second VR viewpoint can include simultaneously fading-out the first VR viewpoint and fading-in the second VR viewpoint. Transitioning from display of the object from the first VR viewpoint to display of the object from the second VR viewpoint includes simultaneously dissolving-out the first VR viewpoint and dissolving-in the second VR viewpoint.

The object can be virtually held in a fixed position in a VR space during display of the object from the first VR viewpoint, transition from display of the object from the first VR viewpoint to display of the object from the second VR viewpoint and display of the object from the second VR viewpoint.

The highlight can be a first highlight. The instructions, when executed by the one or more processors, can cause the computing device to transition, on the display of the computing device without simulated motion, from displaying the object from the second VR viewpoint to displaying the object from the first VR viewpoint with the overlaid first highlight; remove, from the display of the computing device, the first highlight; overlay, on the display of the computing device, a second highlight within the first VR viewpoint of the object; and transition, on the display of the computing device without simulated motion, from displaying the object from the first VR viewpoint with the second highlight to displaying the object from a third VR viewpoint. The third VR viewpoint can be a close-up view of a portion of the object that is within the second highlight in the first VR viewpoint. The portion of the object that is within the second highlight can be different than the portion of the object that is within the first highlight.

In another general aspect, an apparatus can include one or more processors and a non-transitory machine readable media operationally coupled with the one or more processors. The non-transitory machine readable media can have instructions stored thereon that, when executed by the one or more processors, result in the apparatus displaying, on a display of the apparatus, an object from a first virtual reality (VR) viewpoint; overlaying, on the display of the apparatus, a highlight within the first VR viewpoint of the object; and transitioning, on the display of the apparatus without simulated motion, from displaying the object from the first VR viewpoint with the highlight to displaying the object from a second VR viewpoint. The second VR viewpoint can be a close-up view of a portion of the object that is within the highlight in the first VR viewpoint.

Implementations can include one or more of the following features. For example, transitioning from displaying the object from the first VR viewpoint to displaying the object from the second VR viewpoint can include virtually teleporting from the first VR viewpoint to the second VR viewpoint. Transitioning from displaying the object from the first VR viewpoint to displaying the object from the second VR viewpoint can include simultaneously fading-out the first VR viewpoint and fading-in the second VR viewpoint. Transitioning from displaying the object from the first VR viewpoint to displaying the object from the second VR viewpoint can include simultaneously dissolving-out the first VR viewpoint and dissolving-in the second VR viewpoint.

The object can be virtually held in a fixed position in a VR space when displaying the object from the first VR viewpoint, transitioning from displaying the object from the first VR viewpoint to displaying the object from the second VR viewpoint and displaying the object from the second VR viewpoint.

The object is a work of art included in digital content of a VR tour.

The highlight can be a first highlight. The instructions, when executed by the one or more processors, can result in the apparatus transitioning, on the display of the apparatus without simulated motion, from displaying the object from the second VR viewpoint to displaying the object from the first VR viewpoint with the overlaid first highlight; removing, from the display of the apparatus, the first highlight; overlaying, on the display, a second highlight within the first VR viewpoint of the object; and transitioning, on the display of the apparatus without simulated motion, from displaying the object from the first VR viewpoint with the second highlight to displaying the object from a third VR viewpoint. The third VR viewpoint can be a close-up view of a portion of the object that is within the second highlight in the first VR viewpoint. The portion of the object that is within the second highlight can be different than the portion of the object that is within the first highlight.

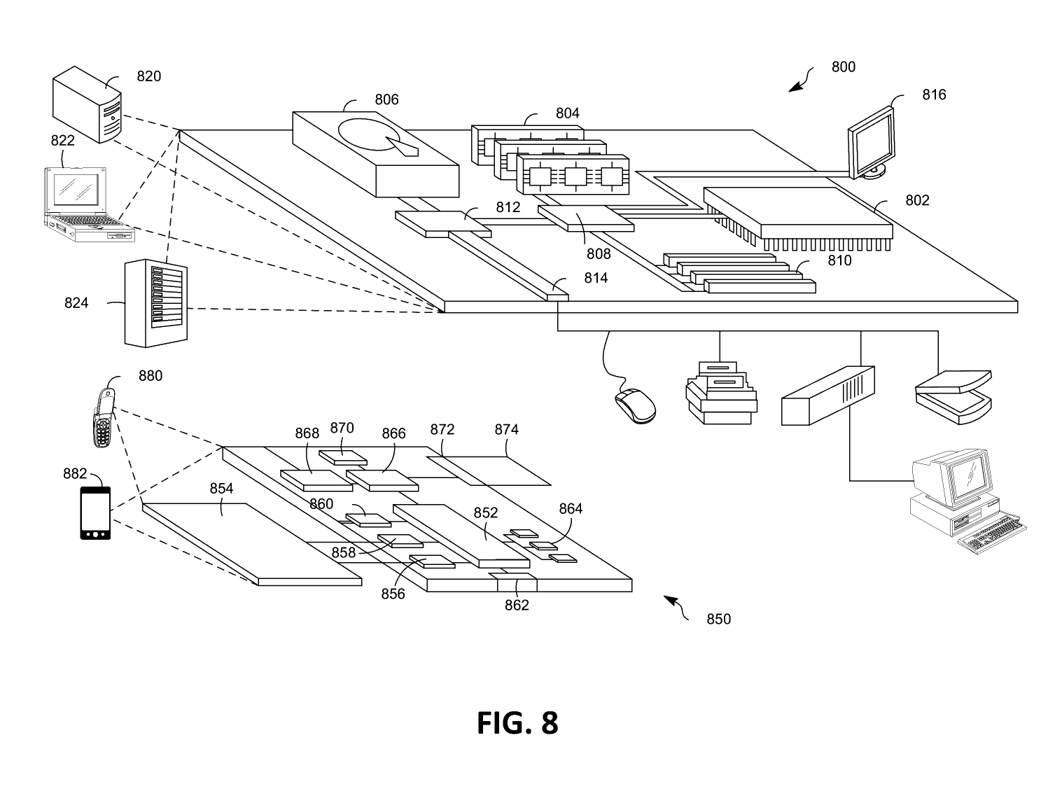

FIG. 8 shows an example of a generic computer device 800 and a generic mobile computer device 850, which may be used with the techniques described here. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, Wi-Fi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification.

In addition, the logic flows, or sequences of operations depicted by the figures do not require the particular order shown, or sequential order, to achieve desirable results. In addition, other steps may be provided, or steps may be eliminated, from the described flows, or sequences of operations, and other components may be added to, or removed from, the described systems or approaches. Accordingly, other embodiments are within the scope of the following claims.

What is claimed is:

1. A computer-implemented method comprising:
displaying, on a display of an electronic device, an object from a first virtual reality (VR) viewpoint;
overlaying, on the display, a highlight within the first VR viewpoint of the object; and
transitioning, on the display of the electronic device without simulated motion, from displaying the object from the first VR viewpoint with the highlight to displaying the object from a second VR viewpoint, the second VR viewpoint being a close-up view of a portion of the object that is within the highlight in the first VR viewpoint.

2. The computer-implemented method of claim 1, wherein transitioning from displaying the object from the first VR viewpoint to displaying the object from the second VR viewpoint includes virtually teleporting from the first VR viewpoint to the second VR viewpoint.

3. The computer-implemented method of claim 1, wherein transitioning from displaying the object from the first VR viewpoint to displaying the object from the second VR viewpoint includes simultaneously fading-out the first VR viewpoint and fading-in the second VR viewpoint.

4. The computer-implemented method of claim 1, wherein transitioning from displaying the object from the first VR viewpoint to displaying the object from the second VR viewpoint includes simultaneously dissolving-out the first VR viewpoint and dissolving-in the second VR viewpoint.

5. The computer-implemented method of claim 1, wherein the object is virtually held in a fixed position in a VR space when:
displaying the object from the first VR viewpoint;
transitioning from displaying the object from the first VR viewpoint to displaying the object from the second VR viewpoint; and
displaying the object from the second VR viewpoint.

6. The computer-implemented method of claim 1, wherein the object is a work of art included in digital content of a VR tour.

7. The computer-implemented method of claim 1, wherein the highlight is a first highlight, the computer-implemented method further comprising:
transitioning, on the display of the electronic device without simulated motion, from displaying the object from the second VR viewpoint to displaying the object from the first VR viewpoint with the overlaid first highlight;
removing, from the display of the electronic device, the first highlight;
overlaying, on the display, a second highlight within the first VR viewpoint of the object; and
transitioning, on the display of the electronic device without simulated motion, from displaying the object from the first VR viewpoint with the second highlight to displaying the object from a third VR viewpoint, the third VR viewpoint being a close-up view of a portion of the object that is within the second highlight in the first VR viewpoint, the portion of the object that is within the second highlight being different than the portion of the object that is within the first highlight.

8. A non-transitory machine readable media having instructions stored thereon, the instructions, when executed by one or more processors, cause a computing device to:
display, on a display of the computing device, an object from a first virtual reality (VR) viewpoint;
overlay, on the display, a highlight within the first VR viewpoint of the object; and
transition, on the display of the computing device without simulated motion, from displaying the object from the first VR viewpoint with the highlight to displaying the object from a second VR viewpoint, the second VR viewpoint being a close-up view of a portion of the object that is within the highlight in the first VR viewpoint.

9. The non-transitory machine readable media of claim 8, wherein transitioning from display of the object from the first VR viewpoint to display of the object from the second VR viewpoint includes virtually teleporting from the first VR viewpoint to the second VR viewpoint.

10. The non-transitory machine readable media of claim 8, wherein transitioning from display of the object from the first VR viewpoint to display of the object from the second VR viewpoint includes simultaneously fading-out the first VR viewpoint and fading-in the second VR viewpoint.

11. The non-transitory machine readable media of claim 8, wherein transitioning from display of the object from the first VR viewpoint to display of the object from the second VR viewpoint includes simultaneously dissolving-out the first VR viewpoint and dissolving-in the second VR viewpoint.

12. The non-transitory machine readable media of claim 8, wherein the object is virtually held in a fixed position in a VR space during:
display of the object from the first VR viewpoint;
transition from display of the object from the first VR viewpoint to display of the object from the second VR viewpoint; and
display of the object from the second VR viewpoint.

13. The non-transitory machine readable media of claim 8, wherein the highlight is a first highlight, the instructions, when executed by the one or more processors, further causing the computing device to:
transition, on the display of the computing device without simulated motion, from displaying the object from the second VR viewpoint to displaying the object from the first VR viewpoint with the overlaid first highlight;
remove, from the display of the computing device, the first highlight;
overlay, on the display of the computing device, a second highlight within the first VR viewpoint of the object; and
transition, on the display of the computing device without simulated motion, from displaying the object from the first VR viewpoint with the second highlight to displaying the object from a third VR viewpoint, the third VR viewpoint being a close-up view of a portion of the object that is within the second highlight in the first VR viewpoint, the portion of the object that is within the second highlight being different than the portion of the object that is within the first highlight.

14. An apparatus comprising:
one or more processors; and
a non-transitory machine readable media operationally coupled with the one or more processors, the non-transitory machine readable media having instructions stored thereon that, when executed by the one or more processors, result in the apparatus:
displaying, on a display of the apparatus, an object from a first virtual reality (VR) viewpoint;
overlaying, on the display of the apparatus, a highlight within the first VR viewpoint of the object; and
transitioning, on the display of the apparatus without simulated motion, from displaying the object from the first VR viewpoint with the highlight to displaying the object from a second VR viewpoint, the second VR viewpoint being a close-up view of a portion of the object that is within the highlight in the first VR viewpoint.

15. The apparatus of claim 14, wherein transitioning from displaying the object from the first VR viewpoint to displaying the object from the second VR viewpoint includes virtually teleporting from the first VR viewpoint to the second VR viewpoint.

16. The apparatus of claim 14, wherein transitioning from displaying the object from the first VR viewpoint to displaying the object from the second VR viewpoint includes simultaneously fading-out the first VR viewpoint and fading-in the second VR viewpoint.

17. The apparatus of claim 14, wherein transitioning from displaying the object from the first VR viewpoint to displaying the object from the second VR viewpoint includes simultaneously dissolving-out the first VR viewpoint and dissolving-in the second VR viewpoint.

18. The apparatus of claim 14, wherein the object is virtually held in a fixed position in a VR space when:
displaying the object from the first VR viewpoint;
transitioning from displaying the object from the first VR viewpoint to displaying the object from the second VR viewpoint; and
displaying the object from the second VR viewpoint.

19. The apparatus of claim 14, wherein the object is a work of art included in digital content of a VR tour.

20. The apparatus of claim 14, wherein the highlight is a first highlight, the instructions, when executed by the one or more processors, further result in the apparatus:
transitioning, on the display of the apparatus without simulated motion, from displaying the object from the second VR viewpoint to displaying the object from the first VR viewpoint with the overlaid first highlight;
removing, from the display of the apparatus, the first highlight;
overlaying, on the display, a second highlight within the first VR viewpoint of the object; and
transitioning, on the display of the apparatus without simulated motion, from displaying the object from the first VR viewpoint with the second highlight to displaying the object from a third VR viewpoint, the third VR viewpoint being a close-up view of a portion of the object that is within the second highlight in the first VR viewpoint, the portion of the object that is within the second highlight being different than the portion of the object that is within the first highlight.
